(19) United States
(12) Patent Application Publication
(10) Pub. No.: US 2007/0298396 A1
(43) Pub. Date: Dec. 27, 2007

(54) Computer executable dynamic presentation system for simulating human meridian points and method thereof

(76) Inventors: Shih-Li Wen, Taipei City (TW); Hsiang-Min Liu, Taipei City (TW); Chang-Chih Lee, Taipei City (TW)

Correspondence Address: RABIN & Berdo, PC, 1101 14TH STREET, NW, SUITE 500, WASHINGTON, DC, 20005, US

(21) Appl. No.: 11/446,412

(22) Filed: Jun. 5, 2006

(51) Int. Cl. G09B 23/28

(52) U.S. Cl. 434/262

(57) ABSTRACT

A computer executable animated presentation system for simulating human meridian points and method thereof. Wherein the positions of human venations and meridian points are marked relative to the body; and with the computer animation technique, and a dynamic three-dimensional presentation for simulating human meridian points, a linear flowing frame of meridians and meridian points are exhibited from inside to outside.

### BACKGROUND OF THE INVENTION

1. Field of Invention

The present invention relates to a computer animated presentation system and method thereof, and more particularly, to a computer executable animated presentation system for simulating human meridian points and method thereof.

2. Related Art

As for the theoretical basis of meridian theory specific to China, the implicit meridians cannot be dynamically presented in martial arts (Wushu) education, meridian-point marking, or martial arts film shooting. Currently, tracks and distribution of the human meridians are generally depicted in plane views, as shown in FIG. 1, or similar to the marking of point & meridian in “Picture of Bronze Figure in Chinese Medicine”. It is for lack of clear, intelligible, and three-dimensional animated presentation for the meridian points where the twelve meridians pass through and for relevant points that a certain disease evolved in the Chinese medical meridian theory.

On the other hand, although computer animation techniques for filming have gradually matured, there are still some technical problems to be overcome due to different animated presentation requirements. As for the current presentation skills in dummy animation games or films, dynamic meridian presentation is limited to the dynamically present human skeleton, for lack of a professional meridian point database, and cannot dynamically present human meridian points.

If the human meridian system can be dynamically presented through a computer animated presentation system for simulating human meridian points, combined with a professional meridian point database, authentic presentation and simulation effects can be achieved for realistic simulation in computer games and filming.

### SUMMARY OF THE INVENTION

In view of above problems, a main object of the present invention is to provide a computer executable animated presentation system for simulating human meridian points, which comprises:

a meridian point database, for storing each meridian point data of the human body; a meridian-related meridian point database, for storing the data of each meridian-related meridian point of the human body, wherein the data of each meridian-related meridian point is established according to the data of the set of meridian points involved and related to each meridian; a body object building module, building-in and marking a set of body objects relative to the meridians and points, according to the data of the human meridian point and that of the meridian-related meridian point; a meridian sequence rule base, storing the sequence for a plurality of meridian-related meridian points; a meridian sequence controlling module, for selecting the data of the human meridian points or the data of the meridian-related meridian points, to output a set of meridian sequence signals for the set of body objects and the set of meridian points; and a meridian sequence animation output module, for receiving the set of meridian sequence signals, so as to simulate the animated presentation of human meridian points by displaying the displacements of the sequential meridian points.

Furthermore, the present invention can further carry out a video recording of a human body to update a body object through a three-dimensional scan device. Furthermore, as for a presentation through the computer animation, a human motion control rule base also can be used to store a plurality of human motion paths, and the human motion paths are selected by a human motion control module, to output a motion signal of the set of body objects, such that the animation simulation appears more authentic.

The present invention further provides a computer executable animated presentation method for simulating human meridian points, which comprises the following steps:

Establishing a meridian point database, for storing the data of each meridian point of the human body; establishing a meridian-related meridian point database, for storing the data of each meridian-related meridian point of the human body, wherein the data of each meridian-related meridian point is established according to the data of the set of meridian points involved and related to each meridian; building-in and marking a set of body objects relative to the meridians and points, according to the data of the human meridian point data and the data of the meridian-related meridian point; establishing sequences for a plurality of meridian-related meridian points; selecting the data of the human meridian point or the data of the meridian-related meridian point data, to output a set of meridian sequence signals for the set of body objects and the set of meridian points; and receiving the set of meridian sequence signals, so as to simulate the animated presentation of human meridian points by displaying the displacements of the sequential meridian points.

The detailed features and advantages of the present invention will be described in detail in the detailed description, the content is sufficient for those skilled in the art to understand the technique of the present invention and to practice accordingly, and any advantage and object of the present invention can be easily understood from the text, claims, and accompanying drawings of this specification.

The above illustration about the summary of the invention and the following detailed description are intended to exemplify and illustrate the principle of the present invention, and to provide further explanation of the claims of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is a plane view of the conventional track and distribution of human meridians;

FIG. 2 is a block diagram of a computer executable animated presentation system for simulating human meridian points according to the present invention;

FIG. 3 is a schematic view of an embodiment of the computer executable animated presentation system for simulating human meridian points operated through a display device according to the present invention;

FIG. 4 is a schematic front view of a device for simulating human meridian points according to the present invention;

FIG. 5 is a schematic back view of the device for simulating human meridian points according to the present invention;

FIG. 6A is a schematic right view of the device for simulating human meridian points according to the present invention;

FIG. 6B is a schematic left view of the device for simulating human meridian points according to the present invention; and

FIG. 7 is a flow chart of a computer executable animated presentation method for simulating human meridian points according to the present invention.

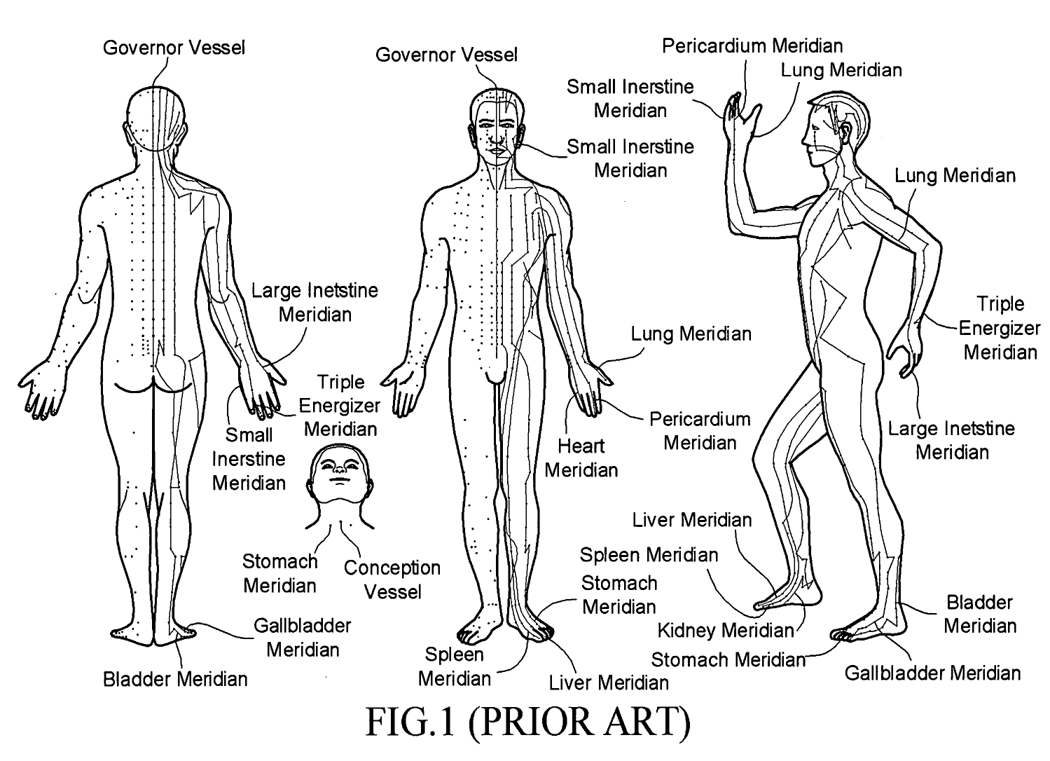

### DETAILED DESCRIPTION OF THE INVENTION

The features and practice of the present invention are illustrated below in detail through most preferred embodiments with reference to the accompanying drawings.

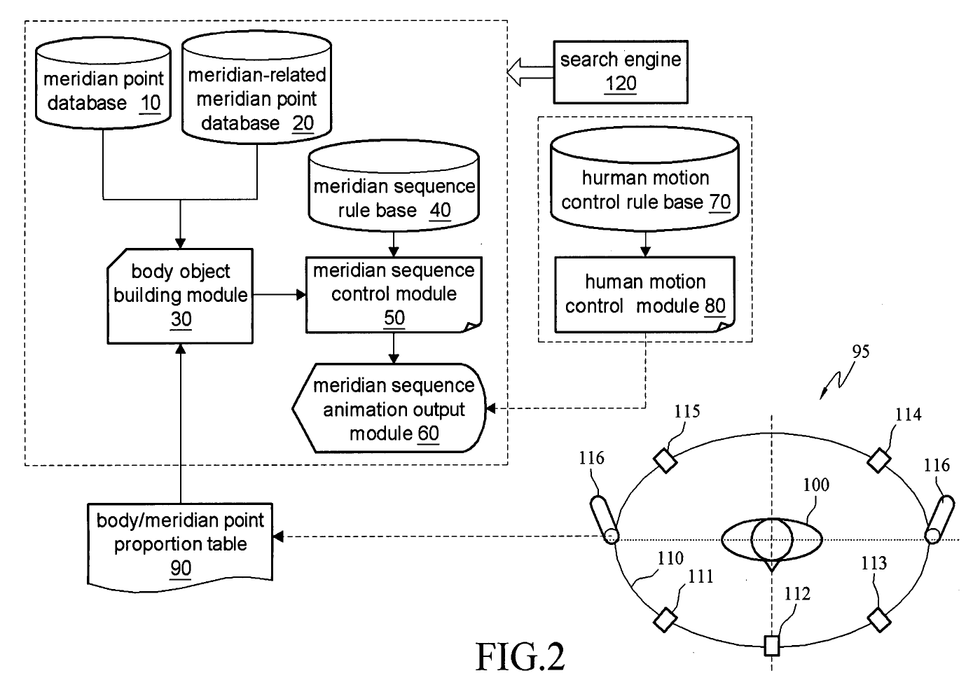

FIG. 2 is a block diagram of a computer executable animated presentation system for simulating human meridian points according to the present invention. The system includes: a meridian point database 10, for storing the data of each meridian point of the human body; a meridian-related meridian point database 20, for storing the data of each meridian-related meridian point of the human body, wherein the data of each meridian-related meridian point is established according to the data of the set of meridian points involved and related to each meridian; a body object building module 30, for building-in and marking a set of body objects relative to the meridians and points, according to the data of the human meridian point and the data of the meridian-related meridian point; a meridian sequence rule base 40, for storing the sequences for a plurality of meridian-related meridian points; a meridian sequence control module 50, for selecting the data of the human meridian point or the data of the meridian-related meridian point, to output a set of meridian sequence signals for the set of body objects and the set of meridian points; and a meridian sequence animation output module 60, for receiving the set of meridian sequence signals, and simulating the human meridian point animated presentation by displaying the displacements of the sequential meridian points, thus a dynamic effect can be achieved.

The present invention further provides another function, that is, a plurality of human motion paths are stored through a human motion control rule base 70; and then the human motion paths are selected by a human motion control module 80 to output a motion signal of the set of body objects; and the motion signal is inputted into the meridian sequence animation output module 60 for simulating the animated presentation of the human motion. Besides, the operating interface can be provided with the function of searching for the selection of meridians, the motion of the human body, relevant point involved in pathology and the like, through a search engine 120, as a basis of the computer executable animated presentation for simulating human meridian points.

The present invention further carries out an actual scan of a human body 100 to be detected and captures images through a three-dimensional scan device 95, for example, muscle irradiation (MRI), used as alternative samples for the above set of body objects. Although the system of the present invention has a predetermined body object, actually the body of each person is different, and the corresponding points are different in accordance with different proportions. And therefore, if the present invention is not applied to virtualize the animation character, but, e.g., is used for medical point diagnose, or computer graphics effects for the animation with a real person, the conversion process for the points of an actual person should be carried out, thus making the points of an actual person an accurate basis of the animated presentation. Thus, the human body 100 to be detected is actually scanned and its images are captured through a three-dimensional scan device 95, with the aim of objectively presenting the point markings of any actual human body 100 to be detected through the system of the present invention.

The three-dimensional scan device 95 includes an adjustable shelf 110, a plurality of infrared detectors 111-115, and a jackpost element 116. The adjustable shelf 110 can be configured as a cyclic structure, or an arch structure, used to fix the infrared detectors 111-115. The number of infrared detectors 111-115 can be adjusted according to the complexity of the curved surface of the human body 100 to be detected, and the limitations for the view angle of the infrared detectors 111-115.

Besides the above infrared detectors, the three-dimensional scan device 95 is further provided with a processing software (not shown) of the host computer, to search for the corresponding points of the signals detected by each detector; to calculate the three-dimensional coordinates of each corresponding point; and then to compile and integrate the data, to construct and smooth a three-dimensional curved surface by utilizing the continuity between the two adjacent points, thus completing the three-dimensional scanning of the human body 100 to be detected. As the technique for three-dimensional scanning of the human body has gradually matured, it is not the emphasis of the present invention, thus, it is illustrated for indicating the feasibility of the present invention, and no specific techniques will be described. The main aim herein is to illustrate the feasibility of the extended application of the present invention, but it is not intended to limit the scope of the present invention to the three-dimensional scan device 95. It should be noted that, the present invention should still establish a body/meridian point proportion table through professional experience, thereby converting the human body to the set of body objects corresponding to the points, with the aid of the finished three-dimensional scan image of the human body 100 to be detected.

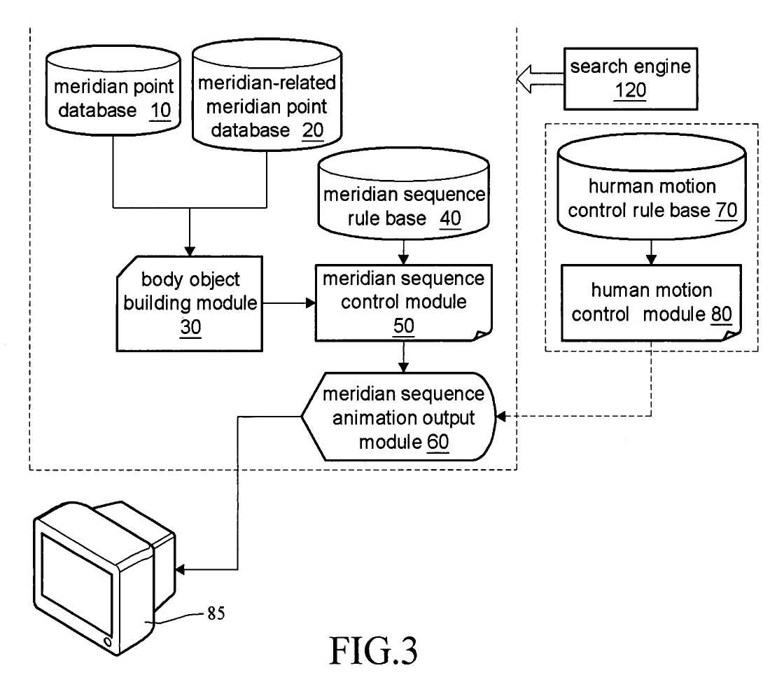

As described above, the meridian sequence animation output module 60 of the present invention receives the set of meridian sequence signals or motion signals, to simulate the animated presentation of human meridian points, and to display the animated presentation for simulating human meridian points on the screen through a display device 85 (referring to FIG. 3).

Through the illustration of above embodiments, the present invention can be applied to the screen-based presentation for the computer simulation system, computer graphics effects presentation for the animation with an actual person, and dynamic separate presentation for simulating human meridian points.

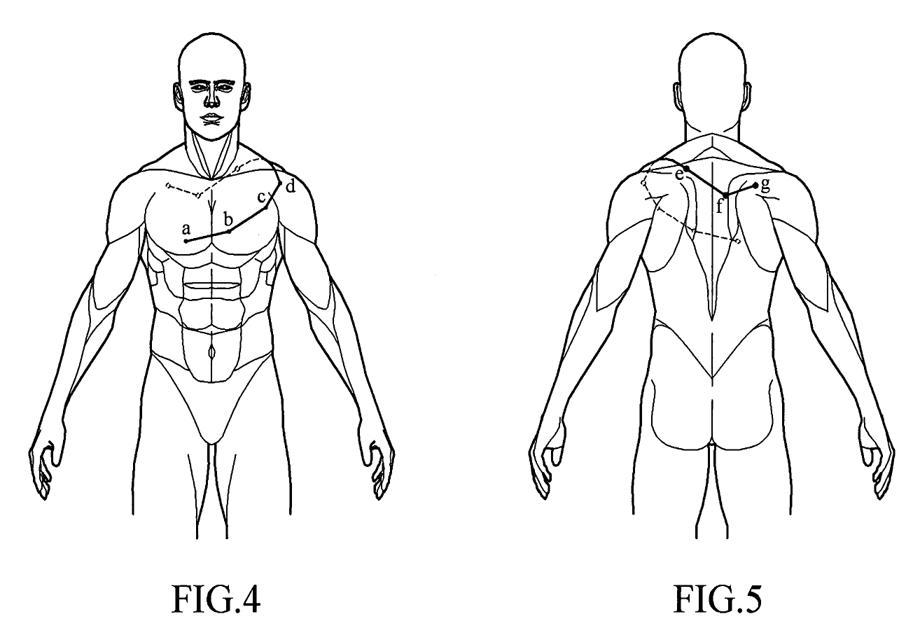

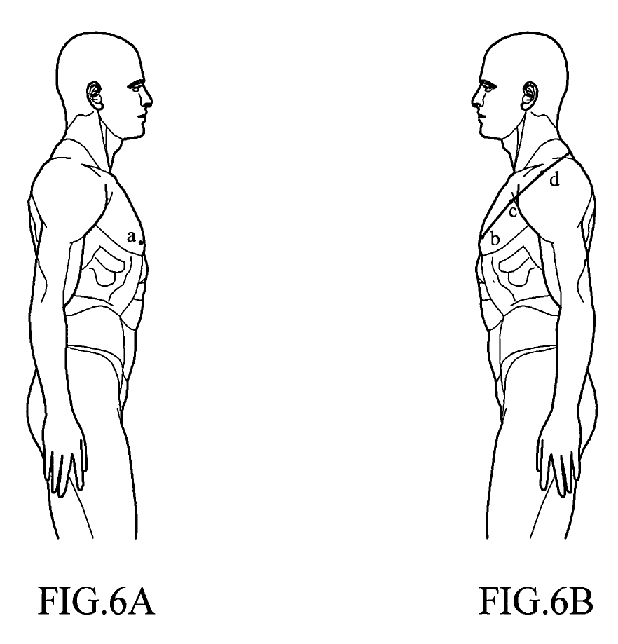

FIGS. 4, 5, 6A, and 6B are schematic views of a computer executable animated presentation for simulating human meridian points according to the present invention. Through the images dynamically captured by the display device, the schematic front, back, right, and left views of the animated presentation for simulating human meridian points of the present invention are shown, for illustrating the three-dimensional meridian relationship of the actual markings of the points in the animated presentation for simulating human meridian point. By displaying the displacements of the sequential meridian points, and through the light-emitting materials for the animated presentation (and dynamic sequential presentation of points a→b→c→d→e→f shown in the figure, wherein the light-emitting materials can be different depending on specific effects for creating the animation, such as, color, slow fading in and fading out, light explosion effect, and the like, but not to limit the application scope of the present invention), the meridian points that may be passed by all meridians, or relevant points involved in certain disease in meridian theory of Chinese medicine can be more clearly and intelligibly presented through the animated presentation for simulating the human meridian point sequence, and the expression manner of the computer animation can be presented by the display device 85. The dynamic expression of the three-dimensional meridian relationship marked on the body is sufficient for achieving an authentic presentation at the Chinese medical application, or the authentic simulation of computer games, being a valuable reference.

Besides, the triggering time difference between the opposing light-emitting elements can be calculated according to the dynamic presentation between two adjacent points (e.g., between points a and b) for inserting another light-emitting element as a relay presentation to smooth the animation elements, such that the motion of the whole meridian sequence can be presented more smoothly.

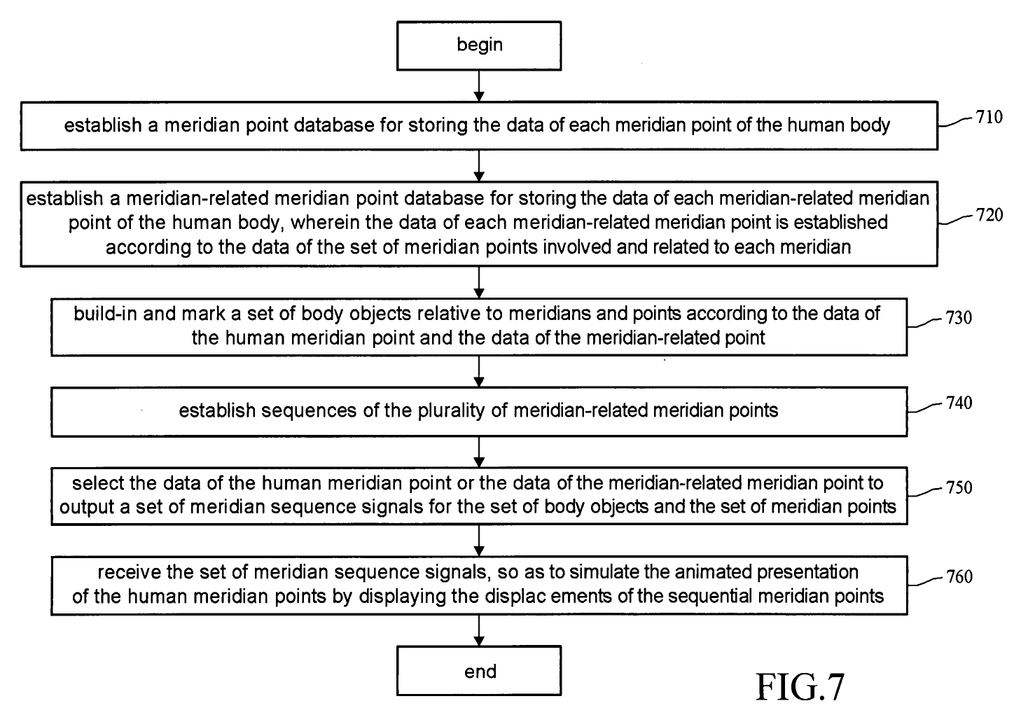

FIG. 7 is a flow chart of the computer executable animated presentation for simulating human meridian points according to the present invention, which includes the following steps: establishing a meridian point database, for storing the data of each meridian point of the human body (Step 710); establishing a meridian-related meridian point database, for storing the data of each meridian-related meridian point of the human body, wherein the data of each meridian-related meridian point is established according to the data of the set of meridian points involved and related to each meridian (Step 720); building-in and marking a set of body objects relative to meridians and points, according to the data of the human meridian point and the data of the meridian-related meridian point (Step 730); establishing the sequences of a plurality of meridian-related meridian points (Step 740); selecting the data of the human meridian point or the data of the meridian-related meridian point to output a set of meridian sequence signals for the set of body objects and the set of meridian points (Step 750); and receiving the set of meridian sequence signals, so as to simulate the animated presentation of the human meridian points by displaying the displacements of the sequential meridian points (Step 760).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A computer executable animated presentation system for simulating human meridian points, comprising:
a meridian point database, for storing the data of each meridian point of the human body;
a meridian-related meridian point database, for storing the data of each meridian-related meridian point of the human body, wherein the data of each meridian-related meridian point is established according to the data of the set of meridian points involved and related to each meridian;
a body object building module, for building-in and marking a set of body objects relative to the meridians and points, according to the data of the human meridian points and the data of the meridian-related meridian points;
a meridian sequence rule base, for storing the sequences of a plurality of meridian-related meridian points;
a meridian sequence control module, for selecting the data of the human meridian point or the data of the meridian-related meridian point, to output a set of meridian sequence signals for the set of body objects and the set of meridian points; and
a meridian sequence animation output module, for receiving the set of meridian sequence signals, so as to simulate the animated presentation of human meridian points by displaying the displacements of the sequential meridian points.

2. The computer executable animated presentation system for simulating human meridian points as claimed in claim 1, wherein it further comprises a three-dimensional scan device for video recording a human body.

3. The computer executable animated presentation system for simulating human meridian points as claimed in claim 2, wherein it further comprises a body/meridian point proportion table, for converting the human body to the set of body objects corresponding to the points.

4. The computer executable animated presentation system for simulating human meridian points as claimed in claim 1, wherein the set of body objects are static body images from several perspectives.

5. The computer executable animated presentation system for simulating human meridian points as claimed in claim 1, wherein it further comprises a human motion control rule base, used for storing a plurality of human motion paths.

6. The computer executable animated presentation system for simulating human meridian points as claimed in claim 5, wherein it further comprises a human motion control module, for selecting the human motion path to output a motion signal for the set of body objects.

7. The computer executable animated presentation system for simulating human meridian points as claimed in claim 5, wherein the human motion path is a two-dimensional path.

8. The computer executable animated presentation system for simulating human meridian points as claimed in claim 5, wherein the human motion path is a three-dimensional path.

9. The computer executable animated presentation system for simulating human meridian points as claimed in claim 1, wherein it further comprises a search engine, for selecting the data of the human meridian point or the data of the meridian-related meridian point.

10. The computer executable animated presentation system for simulating human meridian points as claimed in claim 1, wherein it further comprises a display device to display the animated presentation for simulating human meridian points on the screen.

11. The computer executable animated presentation system for simulating human meridian points as claimed in claim 1, wherein the displacements of the sequential meridian points are sequentially displayed according to the set of meridian sequence signals with the light-emitting materials corresponding to each point, through the specific effects for creating the animation.

12. A computer executable animated presentation method for simulating human meridian points, comprising the following steps:
establishing a meridian point database, for storing the data of each meridian point of the human body;
establishing a meridian-related meridian point database, for storing the data of each meridian-related meridian point of the human body, wherein the data of each meridian-related meridian point is established according to the data of the set of meridian points involved and related to each meridian;
building-in and marking a set of body objects related to the meridians and the points according to the data of the human meridian point and the data of the meridian-related meridian point;
establishing sequences of a plurality of meridian-related meridian points;
selecting the data of the human meridian point or the data of the meridian-related meridian point to output a set of meridian sequence signals for the set of body objects and the set of meridian points; and
receiving the set of meridian sequence signals, so as to simulate the animated presentation of human meridian points by displaying the displacements of the sequential meridian points.

13. The computer executable animated presentation method for simulating human meridian points as claimed in claim 12, wherein the displacements of the sequential meridian points are sequentially displayed according to the set of meridian sequence signals with light-emitting materials corresponding to each point, through the specific effects for creating the animation.
